(19) United States
(12) Patent Application Publication
(10) Pub. No.: US 2022/0001225 A1
(43) Pub. Date: Jan. 6, 2022

(54) FIRE SUPPRESSING PELLETS

(71) Applicant: FIREREIN INC., Napanee (CA)

(72) Inventors: Zackery Michael HODGEN, Napanee (CA); Quincy Andrew EMMONS, Napanee (CA); Rui RESENDES, Napanee (CA)

(21) Appl. No.: 17/295,352

(22) PCT Filed: Nov. 20, 2019
(86) PCT No.: PCT/CA2019/051658

§ 371 Date: May 19, 2021

Related U.S. Application Data
(60) Provisional application No. 62/770,400, filed on Nov. 21, 2018.

(51) Int. Cl. A62D 1/00

(52) U.S. Cl. CPC A62D 1/0014; A62D 1/0064

(57) ABSTRACT

A solid composition, which may be in the form of pellets, comprising at least two biopolymeric thickening agents, such as polysaccharides, wherein said solid composition is capable of forming hydrogels in the presence of water or an aqueous solution. The hydrogel is a water-enhancing, fire-suppressant that is useful for one or more of fire-fighting, fire-suppression, or fire-prevention and exhibits non-Newtonian fluidic, pseudoplastic or thixotropic behaviour.

### FIELD

The present application pertains to the field of firefighting agents. More particularly, the present application relates to fire-suppressing pellets, and methods of manufacture and uses thereof.

### BACKGROUND

Fire is a threat to life, property, and natural, suburban, and urban landscapes worldwide. Forest, brush, and grassland fires destroy acres of natural and suburban landscapes each year; with the total average of acres lost to wildfire increasing since about 1984. This destruction is not only in terms of a loss of timber, wildlife and livestock, but also in erosion, disruption to watershed equilibria, and related problems in natural environments. In suburban, urban, and industrial areas, fire can result in billions of dollars in damage from loss of lives, property, equipment, and infrastructure; not only from the fire itself, but also from water used to extinguish it.

Fire and its constructs are often described by the ‘Fire Tetrahedron’, which defines heat, oxygen, fuel, and a resultant chain reaction as the four constructs required to produce fire; removing any one will prevent fire from occurring. There are five classes of fire: Class A, which comprises common combustibles, such as wood, cloth, etc.; Class B, which comprises flammable liquids and gases, such as gasoline, solvents, etc.; Class C, which comprises live electrical equipment, such as computers, etc.; Class D, which comprises combustible metals, such as magnesium, lithium, etc.; and, Class K, which comprises cooking media, such as cooking oils and fats.

Water remains a first line of defence against certain classes of fires (e.g., class A). However, there are disadvantages to using water to fight fire and/or prevent it from spreading to nearby structures. Often, most of the water directed at a structure does not coat and/or soak into the structure itself to provide further fire protection, but rather is lost to run off and wasted; what water does soak into a structure is usually minimal, providing limited protection as the absorbed water quickly evaporates. Further, water sprayed directly on a fire tends to evaporate at the fire's upper levels, resulting in significantly less water penetrating to the fire's base to extinguish it.

Consequently, significant manpower and local water resources can be expended to continuously reapply water on burning structures to extinguish flames, or on nearby structures to provide fire protection.

To overcome water's limitations as a fire-fighting resource, additives have been developed to enhance water's capacity to extinguish fires. Some of these additives include water-swellable polymers, or “super absorbent polymers,” such as cross-linked acrylic or acrylamide polymers, often found in diapers, that can absorb many times their weight in water, forming gel-like particles. Once dispersed in water, these water-logged particles can be sprayed directly onto a fire, reducing the amount of time and water necessary for fighting fires, as well as the amount of water run off (for example, see U.S. Pat. Nos. 7,189,337 and 4,978,460).

Other additives include acrylic acid copolymers cross-linked with polyether derivatives, which are used to impart thixotropic properties on water (for examples, see U.S. Pat. Nos. 7,163,642 and 7,476,346). Such thixotropic mixtures thin under shear forces, allowing them to be sprayed from hoses onto burning structures or land; once those shear forces are removed, the mixture thickens, allowing it to cling to, and coat, surfaces, extinguish flames, and prevent fire from spreading, or the structure from re-igniting.

Additives that comprise such acrylic acid or acrylamide homo- or copolymers also suffer from drawbacks. These additives are not naturally sourced and are not readily biodegradable. Although these polymeric additives may sometimes be characterized as being biodegradable, they take a very long time to degrade and can persist in the environment following their use during firefights. In addition, because of their water absorbing capacity, they are very difficult to clean up after use, and can create a slippery environment when wet. Furthermore, concentrations of these additives in existing firefighting liquid and powder products are higher than the non-toxic thresholds identified by various environmental and health agencies.

Other concentrates used in the production of fire-fighting gels are solids (e.g., powders), rather than liquids, that form a gel suspension when mixed with water. The solid concentrates can be useful for providing stability during long-term storage. However, the solid concentrates are also associated with drawbacks that have hindered their uptake in the industry. In particular, these solid concentrates can be difficult to suspend uniformly in water, even to the extent that coagulated or undissolved particles can clog firefighting nozzles and hoses during use, and can be associated with high levels of dust formation during use. The dust formation can cause respiratory problems for users, unless they are wearing protective masks or the like. Furthermore, post incident clean up can be very difficult because cross-linked polymer are not easily diluted with water.

On-demand application of the incumbent technology is also very difficult because the induction or eduction point needs to be close to the nozzle. This makes aggressive firefighting tactics very difficult.

There remains a need for environmentally friendly solid firefighting concentrates.

### SUMMARY OF THE INVENTION

In one aspect, there is provided a composition comprising pellets comprising two or more biopolymeric thickening agents.

In an embodiment of the composition as described herein, the two or more biopolymeric thickening agents are non-toxic and biodegradable.

In an embodiment of the composition as described herein, at least one of the two or more biopolymeric thickening agents is a polysaccharide.

In an embodiment of the composition as described herein, the polysaccharide is starch, a polysaccharide gum, or a cellulosic polymer. The starch may be corn starch, wheat starch, arrowroot, potato starch, tapioca, rice starch, or a mixture thereof. The polysaccharide gum may be xanthan gum, guar gum, acacia gum, diutan gum, welan gum, gellan gum, or a mixture thereof. The cellulosic polymer may be cellulose, carboxymethylcellulose, hydroxyethylcellulose, hydroxypropylcellulose, or a mixture thereof.

In an embodiment of the composition as described herein, the two or more biopolymeric thickening agents comprise at least one starch and at least one polysaccharide gum.

In an embodiment of the composition as described herein, the two or more biopolymeric thickening agents comprise at least one polysaccharide gum and at least one cellulosic polymer.

In an embodiment of the composition as described herein, the two or more biopolymeric thickening agents comprise at least one starch, at least one polysaccharide gum, and at least one cellulosic polymer.

In an embodiment of the composition as described herein, the two or more biopolymeric thickening agents comprise at least one starch, two or more polysaccharide gums, and at least one cellulosic polymer.

In an embodiment of the composition as described herein, the two or more biopolymeric thickening agents further comprise at least one lignin. The lignin may be Kraft lignin, lignosulfonate, organosolv lignin, soda lignin, or a mixture thereof.

In an embodiment of the composition as described herein, the pellets are compressed, sheared, and/or heated.

In an embodiment of the composition as described herein, the pellets are obtained from an extrusion process, a prilling process, a pilling process or a briquetting process.

In an embodiment of the composition as described herein, the composition consists of >75%, >80%, >85%, >90%, >95%, >98% or 100%, by weight, consumer-grade components. The consumer-grade components may be food-grade.

In another aspect, there is provided a hydrogel, comprising: 0.1-30 wt % of the composition as described herein; and 70-99.9 wt % of water or an aqueous solution, wherein the hydrogel is a water-enhancing, fire-suppressant, useful for one or more of fire-fighting, fire-suppression, and fire-prevention.

In an embodiment of the hydrogel as described herein, the hydrogel exhibits non-Newtonian fluidic, pseudoplastic or thixotropic behaviour.

In an embodiment of the hydrogel as described herein, the hydrogel's viscosity decreases under stress, and the hydrogel's viscosity increases after the stress ceases or has been removed.

### DETAILED DESCRIPTION

The present inventors have developed solid pellet compositions that can be used to generate effective fire-suppressing hydrogels. As detailed below, the presently disclosed hydrogels and the pellet compositions used to prepare the hydrogels, have been formulated to be non-toxic and environmentally benign. This has been achieved through the use of consumer-grade materials.

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

It must be noted that as used in this specification and the appended claims, the singular forms “a,” “an,” and “the” include plural reference unless the context clearly dictates otherwise. Unless defined otherwise all technical and scientific terms used herein have the same meaning as commonly understood to one of ordinary skill in the art to which this invention belongs.

As used herein, whether in the specification or the appended claims, the transitional terms “comprising”, “including”, “having”, “containing”, “involving”, and the like are to be understood as being inclusive or open-ended (i.e., to mean including but not limited to), and they do not exclude unrecited elements, materials or method steps. Only the transitional phrases “consisting of” and “consisting essentially of”, respectively, are closed or semi-closed transitional phrases with respect to claims and exemplary embodiment paragraphs herein. The transitional phrase “consisting of” excludes any element, step, or ingredient which is not specifically recited. The transitional phrase “consisting essentially of” limits the scope to the specified elements, materials or steps and to those that do not materially affect the basic characteristic(s) of the invention disclosed and/or claimed herein.

It is to be understood that any numerical value inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Unless indicated to the contrary, the numerical parameters set forth in the present disclosure and attached claims are approximations that can vary as desired. At the very least, each numerical parameter should at least be construed in light of the number of reported significant digits and by applying ordinary rounding techniques.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, the term “biopolymer” refers to a polymeric substance occurring in living organisms (e.g., animals, plants, algae, and bacteria) while the term “biopolymeric” describes a substance that is a biopolymer.

As used herein, the term “consumer-grade components” refers to food-grade, personal care-grade, and/or pharmaceutical-grade components. The term “food-grade” is used herein to refer to materials safe for use in food, such that ingestion does not, on the basis of the scientific evidence available, pose a safety risk to the health of the consumer. The term “personal care-grade” is used herein to refer to materials safe for use in topical application such that, topical application does not, on the basis of the scientific evidence available, pose a safety risk to the health of the consumer. The term “pharmaceutical-grade” is used herein to refer to materials safe for use in a pharmaceutical product administered by the appropriate route of administration, such that administration does not, on the basis of the scientific evidence available, pose a safety risk to the health of the consumer. As would be well understood by a person skilled in the art, the consumer-grade components in a composition provided herein are present at levels that would be acceptable for use in food, personal-care products and/or pharmaceuticals.

As used herein, the term “non-toxic” is intended to refer to materials that are non-poisonous, non-hazardous, and not composed of poisonous materials that could harm human health if exposure is limited to moderate quantities and not ingested. Non-toxic is intended to connote harmlessness to humans and animals in acceptable quantities if not ingested and even upon ingestion, does not cause immediate serious harmful effects to the person or animal ingesting the substance. The term non-toxic is not intended to be limited to those materials that are able to be swallowed or injected or otherwise taken in by animals, plants, or other living organisms. The term non-toxic may mean the substance is classified as non-toxic by the Environmental Protection Agency (EPA), the World Health Organization (WHO), the Food and Drug Administration (FDA), the United States Department of Agriculture (USDA), Health Canada, or the like. The term non-toxic is therefore not meant to mean non-irritant or not causing irritation when exposed to skin over prolonged periods of time or otherwise ingested.

As used herein, the term “biodegradable” is intended to refer to a substance that can be degraded or decomposed by the action of a living organism such as plants, algae, bacteria, or fungi. The degradation of a substance could be the substance being broken down physically into smaller pieces or chemically into constituent molecules. The constituent molecules of a biodegradable substance may or may not be metabolised by a living organism such as plants, algae, bacteria or fungi.

When used to describe a pellet composition or the resultant fire-suppressing hydrogel of the present application, the term non-toxic indicates that the composition is non-toxic to humans at concentrations and exposure levels required for effective use as fire-fighting, suppressing, and/or preventing agents, without the need for protective gear.

The term “room temperature” is used herein to refer to a temperature in the range of from about 20° C. to about 30° C.

The term “surface abrasion(s)” as used herein refers to any deviation from a surface's structural norm, such as, but not limited to, holes, fissures, gaps, gouges, cuts, scrapes, cracks, etc.

As used herein, the term “surface adhesion” refers to the ability of a composition to coat and/or adhere to a surface at any orientation (e.g., vertical cling). In referring to the hydrogel compositions of the present application, the term “surface adhesion” further refers to the ability of the hydrogel to adhere to a surface such that adequate firefighting, suppression, and/or protection is afforded as a result of the surface being coated by the hydrogel.

### Hydrogel-Forming Pellet Compositions and Their Components

The present inventors have surprisingly found that biopolymeric thickening agents can form pellets that, when exposed to water, form hydrogels that have surface adhesion and heat absorbing capabilities suitable for firefighting.

The physical properties of compositions provided herein differ from the physical properties of integral solids from which the pellets are formed. Direct comparisons of compositions formed by simply mixing the composition components to compositions comprising pellets formed from the components have demonstrated a substantial improvement in terms of, for example, dust formation, dissolution time, agglomeration, and hydrogel formation. Accordingly, the present application provides compositions comprising pellets comprising at least two biopolymeric thickening agents that form fire-suppressing hydrogels when mixed with water.

Pellets in a composition provided herein may have regular or irregular shapes or surfaces. For example, a pellet may have a round, flat, longitudinally extended, cylindrical, or briquette-like shape. In some embodiments, pellets in a composition provided herein are compressed, sheared, and/or heated, i.e., the at least two or more polymeric thickening agents forming the pellets have been subject to pressure, shear and/or heat.

Pellets in a composition provided herein may sustain a pressure of at least 20 psi without breaking. In addition, pellets in a composition provided herein may effectively form hydrogels when dissolved in water without being associated with high levels of dust formation that may be hazardous to humans.

In some embodiments, the pellets in a composition provided herein have a particle size greater than about 0.088 mm, or greater than about 0.5 mm, or greater than about 1.18 mm. In some embodiments, the average particle size is between about 1.2 mm and about 5 mm, between about 1.18 mm and about 3.2 mm, or between about 3 mm to about 9 mm. In some embodiments, the average particle size of the pellets in a composition provided herein is about 1.3 mm or about 3.2 mm.

In accordance with some embodiments, the pellets in a composition provided herein have a particle size of no more than about 2 cm, or no more than about 1 cm, or no more than about 0.5 cm, or no more than about 0.2 cm, or no more than about 0.1 cm.

As detailed below, water can be used during manufacture of compositions provided herein. It has been found that a certain amount of water (measured as moisture content by weight) can be beneficial in efficient hydrogel production from the composition. Accordingly, in some embodiments, the pellets in a composition provided herein have a moisture content of between about 2% and about 50% by weight, between about 2% and about 30% by weight, between about 5% and about 25% by weight, or between about 8% and about 15% by weight. In some embodiments, the moisture content of the pellets may be at least about 5%, at least about 8%, or at least about 12% by weight. In some embodiments, the moisture content of the pellets may be at most about 25%, at most about 20%, or at least about 15% by weight.

Without being limited by any particular theory, it is expected that pellets having increased moisture content may emit less dust when handled while too much moisture may lead to mould growth.

The present application provides compositions, for use in producing hydrogels in situ, which comprises >75%, by weight, non-toxic, consumer-grade components. In certain embodiments, the components of a composition provided herein can also be biodegradable, renewable and/or naturally-sourced. For example, a composition provided herein may comprise >80%, >85%, >90%, >95% or >98% non-toxic, consumer-grade components.

In some embodiments, at least 75%, by weight, of the components of a composition provided herein are on the GRAS (Generally Recognized as Safe) list maintained by the U.S. Food and Drug Administration. For example, a composition provided herein may comprise >80%, >85%, >90%, >95% or >98%, by weight, GRAS list components.

In some embodiments, at least 75%, by weight, of the components of a composition provided herein are food-grade. For example, a composition provided herein may comprise >80%, >85%, >90%, >95% or >98%, by weight, food-grade components.

### Thickening Agents

Compositions provided herein comprise pellets comprising two or more biopolymeric thickening agents. As used herein, a thickening agent is a substance used to increase the viscosity of liquid mixtures and solutions. Within the context of the present application, suitable biopolymeric thickening agents are selected to provide hydrogels formed from compositions provided herein with surface adhesion and heat absorbing capabilities effective for firefighting.

In some embodiments, at least one of the two or more biopolymeric thickening agents is a polysaccharide, lignin, or protein. In some embodiments, the two or more biopolymeric thickening agents comprise two or more polysaccharides. In some embodiments, the two or more biopolymeric thickening agents comprise at least one polysaccharide and at least one lignin. In some embodiments, the two or more biopolymeric thickening agents comprise at least one polysaccharide and at least one protein. In some embodiments, the polysaccharide is present in the range of 10-100 wt %, 25-100 wt %, 50-100 wt %, or 90-100 wt % of the solid components of the composition. In some embodiments, the lignin is present in the range of 0-90 wt %, 5-75 wt %, or 10-50 wt % of the solid components of the composition.

In some embodiments, the polysaccharide is starch. In some embodiments, the starch is present in the range of 10-50 wt %, 15-40 wt %, or 20-35 wt % of the solid components of the composition. Starch, which is a biodegradable, naturally-sourced polysaccharide, can form gels in the presence of water and heat. Starch-based hydrogels can act as fire retardants due to their high water retaining and surface-adhesion capabilities [loanna G. Mandala (2012). Viscoelastic Properties of Starch and Non-Starch Thickeners in Simple Mixtures or Model Food, Viscoelasticity—From Theory to Biological Applications, Dr. Juan De Vicente (Ed.), ISBN: 978-953-51-0841-2, InTech, DOI: 10.5772/50221. Available from: http://www.intechopen.com/books/viscoelasticity-from-theory-to-biological-applications/viscoelastic-properties-of-starch-and-non-starch-thickeners-in-simple-mixtures-or-model-food]. Examples of starches that are viable for use in compositions provided herein include, but are not limited to, corn starch, wheat starch, arrowroot, potato starch, tapioca, and/or rice starch, or consumer-grade derivatives thereof, which may or may not be naturally sourced. Starches can be modified by cross-linking, pregelatinizing, hydrolysis, acid/base-treating, or heating to modify their structure, leading to alteration of their solubility, swelling, viscosity in solution, or stability.

In some embodiments, the polysaccharide is a polysaccharide gum, such as, but not limited to, guar gum, xanthan gum, acacia gum (gum arabic), diutan gum, welan gum, gellan gum, and/or locust bean gum, and/or derivatives thereof, some of which are used as thickeners in food, pharmaceutical and/or cosmetic industries. In some embodiments, the polysaccharide gum is present in the range of 10-90 wt %, 20-80 wt %, or 30-75 wt % of the solid components of the composition. Polysaccharide gums are polymers of various monosaccharides with multiple branching structures that cause a large increase in the viscosity of a solution. For example, guar gum is a branched polymer of a linear mannose polymer with galactose side-branches, sourced primarily from ground endosperms of guar beans, and reportedly has a greater water-thickening potency than cornstarch; xanthan gum is produced by Xanthomonascamperstris [Tako, M. et al. Carbohydrate Research, 138 (1985) 207-213]; and acacia gum is a branched polymer of arabinose and galactose monosaccharides.

Other polysaccharides can also function as thickening agents, including, for example, agar, sodium alginate, cellulose and derivatives thereof (such as carboxymethylcellulose, hydroxyethylcellulose and hydroxypropylcellulose), pectin, and carrageenan. In some embodiments, cellulose and derivatives thereof may be present in the range of 0-50 wt %, 10-40 wt %, or 20-30 wt % of the solid components of the composition. Like starch, cellulose derivatives have multiple thermally induced structural transitions that require energy, and thus may act as a heat sink when used in a fire-suppressing hydrogel. An example of a cellulosic, hydrogel-forming thickening agent is carboxymethylcellulose, which has found use in personal lubricants, toothpastes, and ice creams as a thickener; it is food-grade and biodegradable, and can absorb water at concentrations as low as 1% in water.

Lignin and derivatives thereof, such as Kraft lignin, lignosulfonate, organosolv lignin, and soda lignin, can also function as thickening agents. The inventors have observed that addition of lignosulfonate to a pellet composition may result in the formation of hydrogels with improved viscosities compared to pellet compositions lacking lignosulfonate. Lignosulfonate is also known to be an intumescent, or a compound that swells when exposed to excessive heat; when incorporated into a hydrogel, it may thus help to provide a foam-like barrier between a fire and a surface.

Certain proteins can also function as thickening agents. Protein thickening agents include, for example, collagen, gelatin, gluten, soy protein, milk protein, and corn protein.

In some embodiments, the pellets of a composition provided herein comprise a combination of at least two thickening agents, for example, a mixture of starch and one or more additional thickening agents. The additional thickening agents can, for example, be a mixture of polysaccharide gums, such as vegetable or plant gums. For example, a composition provided herein may comprise pellets made up of a blend of xanthan gum, guar gum and corn starch (for example, having a gum:starch ratio from 1:1 to 5:1 and a xanthan gum:guar gum ratio of from 1:1 to 3:1); or a blend of xanthan gum, acacia gum and corn starch (for example, having a gum:starch ratio from 1:1 to 5:1 and a xanthan gum:acacia gum ratio of from 1:1 to 3:1); or a blend of acacia gum, guar gum and corn starch (for example, having a gum:starch ratio from 1:1 to 5:1 and a acacia gum:guar gum ratio of from 1:1 to 3:1). In some embodiments, the two or more biopolymeric thickening agents comprise at least one polysaccharide gum and at least one cellulosic polymer (for example, having a gum:cellulosic polymer ratio from 1:1 to 5:1). In some embodiments, the two or more biopolymeric thickening agents comprise two or more polysaccharide gums, and at least one cellulosic polymer, such as xanthan gum, guar gum and hydroxypropylcellulose (for example, having a gum:cellulosic polymer ratio from 1:1 to 5:1 and a xanthan gum:guar gum ratio of from 1:1 to 3:1). In some embodiments, the two or more biopolymeric thickening agents comprise at least one starch, at least one polysaccharide gum, and at least one cellulosic polymer, such as corn starch, xanthan gum, and hydroxyethylcellulose (for example, having a polysaccharide:cellulosic polymer ratio from 1:1 to 5:1 and a gum:starch ratio of from 1:1 to 3:1). In some embodiments, the two or more biopolymeric thickening agents comprise at least one starch, two or more polysaccharide gums, and at least one cellulosic polymer. In some embodiments, the two or more biopolymeric thickening agents comprise at least one starch, two or more polysaccharide gums, and at least one lignin, such as xanthan gum, guar gum, corn starch, and lignosulfonate (for example, having a polysaccharide:lignin ratio from 1:1 to 20:1 and a gum:starch ratio of from 1:1 to 3:1).

### Additives

Other components, or additives, can be added to compositions provided herein in order to affect or alter one or more properties of the compositions or the hydrogels formed from the compositions. The appropriate additive(s) can be incorporated as required for a particular use. For example, additives can be added to affect the viscosity and/or stability of a composition provided herein, and/or the resultant hydrogel. Additional additives that can be incorporated in a composition provided herein and the resultant hydrogel include, but are not limited to, binding agents, pH modifiers, suspending agents (e.g., surfactants, emulsifiers, clays), salts, hydrogen-bonding disruptors (e.g., glucose, silica), preservatives, anti-microbial agents, antifungal agents and pigments or dyes/coloring agents.

Specific, non-limiting examples of non-toxic, consumer-grade additives include: sodium and magnesium salts (e.g., borax, sodium bicarbonate, sodium sulphate, magnesium sulphate, sodium chloride), which can affect hydrogel viscosity and/or stability [Kesavan, S. et al., Macromolecules, 1992, 25, 2026-2032; Rochefort, W. E., J. Rheol. 31, 337 (1987)]; chitosan or epsilon polylysine, which can act as anti-microbials [Polimeros: Ciencia e Tecnologia, vol. 19, no 3, p. 241-247, 2009; http://www.fda.gOv/ucm/groups/fdagov-public/@fdagov-foods-gen/documents/document/ucm 267372.pdf (accessed Sep. 26, 2014)]; consumer-grade preservatives such as Proxel™ GXL, Proxel™ BD20, and potassium sorbate and salts thereof; citric acid for modifying pH; potassium acetate and sodium bicarbonate, which can help sequestering Class B (which comprises flammable liquids and gases, such as gasoline, solvents, etc.) or K (which comprises cooking media, such as cooling oils and fats) fires; vegetable oils and lecithin as binding agents; and pectin, which can aid in the formation of hydrogels.

In some embodiments, compositions provided herein comprise a binding agent, for example, water, a vegetable oil (e.g., canola oil), or lecithin, at a concentration of no more than about 25% by weight (e.g., no more than about 20% by weight, no more than about 15% by weight, no more than about 10% by weight, or no more than about 5% by weight). Without being limited by any particular theory, it is expected that the addition of binding agents would help binding of the at least two biopolymeric thickening agents, increase solubility of the pellets, and/or improve firefighting against certain classes of fire.

In some embodiments, compositions provided herein do not require the addition or inclusion of suspending agents, or rheology modifiers, or both, in order to effectively produce a fire suppressing hydrogel following dissolution or partial dissolution of the composition in water.

As would be readily appreciated by a worker skilled in the art, additive(s) can be added to a composition provided herein, or additive(s) can be added during formation of a hydrogel provided herein, or additive(s) can be added to a hydrogel provided herein. When an additive is added to a composition provided herein, the additive can be incorporated in the pellets or can be added after pellet formation.

### Manufacture of Compositions

The present application further provides methods of producing a composition comprising pellets comprising at least two biopolymeric thickening agents.

In accordance with one aspect, there is provided a process producing compositions provided herein that comprises blending at least two biopolymeric thickening agents with water, extruding the resultant blend, drying the extrudate, and milling the extrudate to form pellets having the desired particle size. Optionally, the process additionally comprises sieving the milled pellets to remove fines (i.e., very small particles or powder).

As would be readily understood by a worker skilled in the art, an extrusion process generally comprises blending the components, optionally with water or steam, then forcing the blend through an opening in a perforated plate or die and cutting material to a particular size. The selection of the die and cutter is based on the required particle size. The step of forcing the components through the perforated plate or die is performed by an extruder, which consists of a large rotating screw tightly fitting within a stationary barrel. Regions, or zones, along the barrel can be held at set temperatures that may be the same or different between different zones. Optionally, temperatures are selected to provide “cooking” of the material as it passes through the extruder. As the material passes through the die and cutter it can expand from the reduction of forces and from release of moisture and heat. This expansion process is expected to provide a degree of porosity in the pellets, which is maintained as the pellets cool and dry.

An alternative process for producing compositions provided herein comprises blending at least two biopolymeric thickening agents with water, heating the resultant blend for a period of time, cooling the blend and milling the cooled blend to the desired particle size.

Another alternative process that may be employed for producing compositions provided herein comprises agglomerating at least two biopolymeric thickening agents and water or an aqueous solution, optionally in the presence of a binder; compressing the agglomerated agents to produce briquettes, pills or other large compressed pieces; optionally reducing the size of the briquettes, pills or other large compressed pieces produced, for example, by granulation using a mill; and further optionally separating the milled materials by size, for example, through sieving to remove fines.

The compression step may comprise prilling processes (e.g., adding water to at least two biopolymeric thickening agents at a 1 to 5% concentration to a rotating drum, the speed and diameter of which decide the particle size of pellets obtained from this process), pilling processes (e.g., blending at least two biopolymeric thickening agents with water, passing the resultant blend through rollers to press the resultant blend in the form of a tablet), and briquetting processes.

In some embodiments, pellets in a composition provided herein are obtained from a process comprising a size reduction step such as milling. In some embodiments, pellets in a composition provided herein are obtained from a process not comprising a size reduction step.

Without being limited by theory, it is expected that the at least two biopolymeric thickening agents form hydrogen bonds during the manufacturing processes, resulting in improvements in terms of, for example, dust formation, dissolution time, agglomeration, and hydrogel formation, of the pellets obtained from the manufacturing processes.

### Hydrogel Formation and Application

A water-enhancing, fire-suppressing hydrogel can be formed by mixing a composition provided herein, with water or an aqueous solution. The term “hydrogel” is used herein to refer to the gel-like material formed from mixing a composition provided herein in water. The hydrogel is an aqueous solution of most or all of the components of a composition provided herein, with any undissolved components present as a suspension in the hydrogel. In accordance with one embodiment the hydrogel comprises between about 1% and 3% by weight of a composition provided herein, with the remainder being water or the aqueous solution

When applied using firefighting equipment, a composition provided herein is mixed with the equipment's water supply or mixed with water in a reservoir, and then applied to target objects (such as, structures, edifices and/or landscape elements) to extinguish, suppress or prevent fire or to protect the target objects from fire. Using a composition provided herein, the hydrogel is often prepared in bulk, but can also be prepared using an appropriate on demand system, such as a solid phase educator (e.g., the dry inductor from Pattison, the Cleanload™ chemical inductor from Dultmeier, or a Handler™ chemical handling system from Polywest).

Firefighting equipment useful in applying hydrogels provided herein, comprises means for spraying, or otherwise applying, the resultant hydrogel onto the target objects. In one embodiment, the firefighting equipment additionally comprises a means for mixing a composition provided herein with water or an aqueous solution and a reservoir for holding the composition until required; the reservoir being in fluid communication with the mixing means such that the composition can be moved from the reservoir to the mixing means for mixing with the water or aqueous solution. In another embodiment, the firefighting equipment additionally comprises means for introducing water or an aqueous solution to the means for mixing, or a reservoir fluidly connected to the means for mixing, such that the water or aqueous solution can be moved from the reservoir to the mixing means for mixing with a composition provided herein.

Non-limiting examples of firefighting equipment suitable for application of the hydrogel prepared from a composition provided herein include fire extinguishers (e.g., an air over water extinguisher), spray nozzle-equipped backpacks, or sprinkler systems. The firefighting equipment can be mounted on or in a vehicle, such as, a truck, airplane or helicopter.

In accordance with one embodiment, in which a hydrogel provided herein is used for firefighting using fire trucks, or other firefighting vehicles, including aircrafts, the hydrogel is formed and used via the following, non-limiting process: a composition provided herein is added to a vehicle's water-filled dump tank and/or other portable tank, and mixed with the water via a circulating hose, or equivalent thereof; pumping the hydrogel, once formed, out of the tank(s), and applying the hydrogel to the target objects (e.g., edifices or landscape elements), via a hard suction hose, or equipment equivalent thereof.

In an alternative embodiment, a composition provided herein is added directly to a vehicle's onboard water tank, either manually or via an injection system, and mixed by agitation with optional recirculation/overpumping in the tank. In one example of this embodiment, the injection system comprises an ‘after the pump’ system that injects specified amounts of the composition into water that has passed through the vehicle's pump, and is about to enter the fire hose; friction of, or the shear forces caused by, the water moving through the hose assists in mixing the composition with the water to produce the hydrogel in the hose. In another specific example, the injection system pumps the composition from a dedicated reservoir to an injection pipe that introduces the composition into the water just prior to the hose line; a computerized system calculates water flow via a flow meter on said injection pipe to inject required amounts of the composition into the pipe and hose stream via a specially designed quill.

In an alternative embodiment, a composition provided herein is metered into the water stream before the pump or proportioned via use of an educator (solid into liquid).

Fire-fighting vehicles suitably equipped with an in-line injection system, allow a composition provided herein to be added directly in-line with the water, which can then be mixed via physical agitation and/or shear forces within the hose itself.

As would be readily appreciated by a worker skilled in the art, although the methods for hydrogel formation described above specifically refer to a firefighting truck, such methods are equally applicable to firefighting using aircraft, such as airplanes or helicopters, where the hydrogel is formed and then air dropped from the aircraft.

In another embodiment, a hydrogel is made from a composition provided herein at the time of firefighting using fire fighting backpacks. In this embodiment the composition can be added to directly to the backpack's water-filled reservoir, and manually or mechanically shaken to form the hydrogel. Once formed, the hydrogel can be applied to requisite objects, or surfaces, via the backpacks' spray-nozzles.

In another embodiment, a composition provided herein can be added to a sprinkler system's water supply, such that, upon activation as a result heat, smoke, and/or fire detection, the system sprays the resultant hydrogel rather than simply water (as in current practice). In one embodiment, once a sprinkler system is activated, a dedicated pump system injects the composition into the sprinkler's water system, producing a hydrogel with properties compatible with the sprinkler's flow requirements, prior to being applied to an object or area (e.g., an edifice, room or landscape area). In another embodiment, the sprinkler system comprises sprinkler heads designed to provide an optimized spray pattern for applying a hydrogel to an object or area (e.g., an edifice, room or landscape area).

In yet another embodiment, a sprinkler system for applying hydrogels provided herein comprises: a dedicated pump for injecting a composition provided herein into the sprinkler's water system or for drawing the composition into the sprinkler system's water stream; a sprinkler head designed to provide an optimized spray pattern for hydrogel application; a computerized system to calculate water and/or hydrogel flow; a flow meter to detect water flow in dry pipes; and, a point of injection designed to introduce the composition into the water in such a way that is compatible with the sprinkler system and its intended use.

### Hydrogel Firefighting Properties

Hydrogels, as formed from compositions provided herein, are suitable for use as firefighting agents due to their physical and/or chemical properties. The hydrogels are more viscous than water, and generally resist evaporation, run-off, and/or burning when exposed to high temperature conditions (e.g., fire), due to their water-absorbing, viscosity-increasing components. These hydrogels also exhibit shear-thinning, thixotropic, pseudoplastic, and/or non-Newtonian fluidic behaviour, such that their viscosity decreases when they are subjected to stresses, such as, but not limited to, shear stresses, wherein their viscosity increases again when those stresses are removed.

Consequently, once formed, the present hydrogels can be sprayed via hoses and/or spray-nozzles onto burning objects (e.g., edifices or landscape elements) in a manner similar to water; and, once the hydrogels are no longer subjected to the stresses of being sprayed, their viscosity will increase to be greater than that of water. As a result, the hydrogels coat and cling, at virtually any angle, to surfaces they are applied to, allowing them to extinguish fires by displacing oxygen and cooling surfaces, prevent fire flash-over, and/or further protect surfaces from re-ignition via the hydrogels' general resistance to evaporation, run-off, and/or burning.

Further, as the viscosity increase would not be instantaneous, the hydrogels can ‘creep’ or ‘ooze’ into surface abrasions or structural gaps, such as, but not limited to, cracks, holes, fissures, etc., in an edifice or landscape element, coating and protecting surfaces that would otherwise be difficult to protect with water, or other firefighting agents such as foams, due to evaporation or run-off. This will contribute an element of penetrative firefighting to a firefighter's arsenal: once the hydrogel's viscosity has increased, it will form a protective layer in, on, under and/or around said cracks, surface abrasions, structural gaps or the like. Also, use of the herein described hydrogels can minimize water damage to surfaces, since use of the hydrogels would replace the direct use of water in firefighting.

In one example, a hydrogel provided herein is applied at the head of an approaching fire, either as a fire break or to protect a property (e.g., cottage, house, or commercial or municipal building). Firefighters can proceed via “coat and approach” to protect firefighters inside a circumference set by a coating of the hydrogel, allowing the firefighters to create a protected route of egress.

Since the components of compositions provided herein are water soluble, the resultant hydrogel is easily cleaned up after use, simply by using water.

### EMBODIMENTS

Particular embodiments of the invention include, without limitation, the following:
1. A composition comprising pellets comprising two or more biopolymeric thickening agents.
2. The composition of embodiment 1, wherein at least one of the two or more biopolymeric thickening agents is a polysaccharide (optionally in the range of 10-100 wt %, 25-100 wt %, 50-100 wt %, or 90-100 wt % of the solid components of the composition), lignin (optionally in the range of 0-90 wt %, 5-75 wt %, or 10-50 wt % of the solid components of the composition), or protein.
3. The composition of embodiment 1 or 2, wherein the two or more biopolymeric thickening agents comprise two or more polysaccharides.
4. The composition of embodiment 1 or 2, wherein the two or more biopolymeric thickening agents comprise at least one polysaccharide and at least one lignin.
5. The composition of embodiment 1 or 2, wherein the two or more biopolymeric thickening agents comprise at least one polysaccharide and at least one protein.
6. The composition of any one of embodiments 2 to 5, wherein the polysaccharide is starch (optionally in the range of 10-50 wt %, 15-40 wt %, or 20-35 wt % of the solid components of the composition), a polysaccharide gum (optionally in the range of 10-90 wt %, 20-80 wt %, or 30-75 wt % of the solid components of the composition), a cellulosic polymer (optionally in the range of 0-50 wt %, 10-40 wt %, or 20-30 wt % of the solid components of the composition), or a mixture thereof.
7. The composition of embodiment 6, wherein the starch is corn starch or a derivative thereof, wheat starch or a derivative thereof, arrowroot or a derivative thereof, potato starch or a derivative thereof, tapioca or a derivative thereof, rice starch or a derivative thereof, or a mixture thereof.
8. The composition of embodiment 7, wherein the starch is corn starch or a derivative thereof.
9. The composition of embodiment 6, wherein the polysaccharide gum is xanthan gum or a derivative thereof, guar gum or a derivative thereof, acacia gum or a derivative thereof, diutan gum or a derivative thereof, welan gum or a derivative thereof, gellan gum or a derivative thereof, locust bean gum or a derivative thereof, or a mixture thereof.
10. The composition of embodiment 9, wherein the polysaccharide gum is xanthan gum or a derivative thereof, guar gum or a derivative thereof, acacia gum or a derivative thereof, or a mixture thereof.
11. The composition of embodiment 6, wherein the cellulosic polymer is cellulose or a derivative thereof.
12. The composition of embodiment 11, wherein the cellulose derivative is carboxymethylcellulose, hydroxyethylcellulose, hydroxypropylcellulose, or a mixture thereof.
13. The composition of any one of embodiments 1 to 12, wherein the two or more biopolymeric thickening agents comprise at least one starch and at least one polysaccharide gum.
14. The composition of embodiment 13, wherein the two or more biopolymeric thickening agents comprise xanthan gum, acacia gum and corn starch.
15. The composition of embodiment 13, wherein the two or more biopolymeric thickening agents comprise xanthan gum, guar gum and corn starch.
16. The composition of any one of embodiments 1 to 12, wherein the two or more biopolymeric thickening agents comprise at least one polysaccharide gum and at least one cellulosic polymer.
17. The composition of embodiment 16, wherein the two or more biopolymeric thickening agents comprise xanthan gum, guar gum and hydroxypropylcellulose.
18. The composition of any one of embodiments 1 to 12, wherein the two or more biopolymeric thickening agents comprise at least one starch, at least one polysaccharide gum, and at least one cellulosic polymer.
19. The composition of embodiment 18, wherein the two or more biopolymeric thickening agents comprise corn starch, xanthan gum, and hydroxyethylcellulose.
20. The composition of embodiment 18, wherein the two or more biopolymeric thickening agents comprise at least one starch, two or more polysaccharide gums, and at least one cellulosic polymer.
21. The composition of any one of embodiments 2 to 20, wherein the lignin is Kraft lignin, lignosulfonate, organosolv lignin, soda lignin, or a mixture thereof.
22. The composition of embodiment 21, wherein the lignin is lignosulfonate.
23. The composition of any one of embodiments 1 to 22, wherein the two or more biopolymeric thickening agents comprise xanthan gum, guar gum, corn starch, and lignosulfonate.
24. The composition of any one of embodiments 2 to 23, wherein the protein is gluten, milk protein, soy protein, corn protein, or a mixture thereof.
25. The composition of any one of embodiments 1 to 24, wherein the pellets are compressed, sheared, and/or heated.
26. The composition of embodiment 25, wherein the pellets are sheared and heated.
27. The composition of embodiment 25, wherein the pellets are compressed.
28. The composition of embodiment 25, wherein the pellets are heated.
29. The composition of any one of embodiments 1 to 28, wherein the pellets are obtained from an extrusion process, a prilling process, a pilling process or a briquetting process, each of which comprises an optional size reduction step and a further optional separation by size step.
30. The composition of embodiment 29, wherein the pellets are obtained from an extrusion process.
31. The composition of embodiment 29, wherein the pellets are obtained from a prilling process.
32. The composition of embodiment 29, wherein the pellets are obtained from a pilling process.
33. The composition of embodiment 29, wherein the pellets are obtained from a briquetting process.
34. The composition of any one of embodiments 1 to 33, wherein the pellets have an average particle size of about 0.088 mm to about 2 cm.
35. The composition of any one of embodiments 1 to 33, wherein the pellets have an average particle size of about 0.088 mm to about 1 cm.
36. The composition of any one of embodiments 1 to 33, wherein the pellets have an average particle size of about 0.088 mm to about 0.5 cm.
37. The composition of any one of embodiments 1 to 33, wherein the pellets have an average particle size of about 0.088 mm to about 0.2 cm.
38. The composition of any one of embodiments 1 to 33, wherein the pellets have an average particle size of about 0.088 mm to about 0.1 cm.
39. The composition of any one of embodiments 1 to 33, wherein the pellets have an average particle size of about 0.088 mm to about 3.2 mm.
40. The composition of any one of embodiments 1 to 33, wherein the pellets have an average particle size of about 0.5 mm to about 2 cm.
41. The composition of any one of embodiments 1 to 33, wherein the pellets have an average particle size of about 0.5 mm to about 1 cm.
42. The composition of any one of embodiments 1 to 33, wherein the pellets have an average particle size of about 0.5 mm to about 0.5 cm.
43. The composition of any one of embodiments 1 to 33, wherein the pellets have an average particle size of about 0.5 mm to about 0.2 cm.
44. The composition of any one of embodiments 1 to 33, wherein the pellets have an average particle size of about 0.5 mm to about 0.1 cm.
45. The composition of any one of embodiments 1 to 33, wherein the pellets have an average particle size of about 0.5 mm to about 3.2 mm.
46. The composition of any one of embodiments 1 to 33, wherein the pellets have an average particle size of about 1.18 mm to about 2 cm.
47. The composition of any one of embodiments 1 to 33, wherein the pellets have an average particle size of about 1.18 mm to about 1 cm.
48. The composition of any one of embodiments 1 to 33, wherein the pellets have an average particle size of about 1.18 mm to about 0.5 cm.
49. The composition of any one of embodiments 1 to 33, wherein the pellets have an average particle size of about 1.18 mm to about 0.2 cm.
50. The composition of any one of embodiments 1 to 33, wherein the pellets have an average particle size of about 1.18 mm to about 0.1 cm.
51. The composition of any one of embodiments 1 to 33, wherein the pellets have an average particle size of about 1.18 mm to about 3.2 mm.
52. The composition of any one of embodiments 1 to 33, wherein the pellets have an average particle size of about 3 mm to about 9 mm.
53. The composition of any one of embodiments 1 to 52, wherein the pellets have a moisture content of about 2% by weight to about 50% by weight.
54. The composition of any one of embodiments 1 to 52, wherein the pellets have a moisture content of about 2% by weight to about 30% by weight.
55. The composition of any one of embodiments 1 to 52, wherein the pellets have a moisture content of about 2% by weight to about 25% by weight.
56. The composition of any one of embodiments 1 to 52, wherein the pellets have a moisture content of about 2% by weight to about 20% by weight.
57. The composition of any one of embodiments 1 to 52, wherein the pellets have a moisture content of about 2% by weight to about 15% by weight.
58. The composition of any one of embodiments 1 to 52, wherein the pellets have a moisture content of about 2% by weight to about 10% by weight.
59. The composition of any one of embodiments 1 to 52, wherein the pellets have a moisture content of about 5% by weight to about 50% by weight.
60. The composition of any one of embodiments 1 to 52, wherein the pellets have a moisture content of about 5% by weight to about 30% by weight.
61. The composition of any one of embodiments 1 to 52, wherein the pellets have a moisture content of about 5% by weight to about 25% by weight.
62. The composition of any one of embodiments 1 to 52, wherein the pellets have a moisture content of about 5% by weight to about 20% by weight.
63. The composition of any one of embodiments 1 to 52, wherein the pellets have a moisture content of about 5% by weight to about 15% by weight.
64. The composition of any one of embodiments 1 to 52, wherein the pellets have a moisture content of about 5% by weight to about 10% by weight.
65. The composition of any one of embodiments 1 to 52, wherein the pellets have a moisture content of about 10% by weight to about 50% by weight.
66. The composition of any one of embodiments 1 to 52, wherein the pellets have a moisture content of about 10% by weight to about 30% by weight.
67. The composition of any one of embodiments 1 to 52, wherein the pellets have a moisture content of about 10% by weight to about 25% by weight.
68. The composition of any one of embodiments 1 to 52, wherein the pellets have a moisture content of about 10% by weight to about 20% by weight.
69. The composition of any one of embodiments 1 to 52, wherein the pellets have a moisture content of about 10% by weight to about 15% by weight.
70. The composition of any one of embodiments 1 to 52, wherein the pellets have a moisture content of at least about 5% by weight.
71. The composition of any one of embodiments 1 to 52, wherein the pellets have a moisture content of at least about 8% by weight.
72. The composition of any one of embodiments 1 to 52, wherein the pellets have a moisture content of at least about 12% by weight.
73. The composition of any one of embodiments 1 to 72, further comprising an additive.
74. The composition of embodiment 73, wherein the additive is a preservative.
75. The composition of embodiment 73, wherein the additive is a binding agent.
76. The composition of embodiment 75, wherein the binding agent is water, a vegetable oil or lecithin.
77. The composition of embodiment 76, wherein the vegetable oil is canola oil.
78. The composition of embodiment 73, wherein the additive is a salt.
79. The composition of embodiment 78, wherein the salt is sodium chloride or sodium bicarbonate.
80. The composition of embodiment 73, wherein the additive is glucose.
81. The composition of embodiment 73, wherein the additive is silica.
82. The composition of any one of embodiments 1 to 81, which forms a hydrogel when dissolved in water.
83. The composition of any one of embodiments 1 to 82, which does not comprise a suspending agent, or a rheology modifier, or both.
84. The composition of any one of embodiments 1 to 83, wherein the two or more biopolymeric thickening agents are non-toxic and biodegradable.
85. The composition of any one of embodiments 1 to 84, wherein the two or more biopolymeric thickening agents are naturally sourced.
86. The composition of any one of embodiments 1 to 85, wherein the composition consists of >80%, >85%, >90%, >95%, >98% or 100%, by weight, consumer-grade components.
87. The composition of embodiment 86, wherein the consumer-grade components are food-grade.
88. A hydrogel, comprising: 0.1-30 wt % of the composition of any one of embodiments 1 to 87; and 70-99.9 wt % of water or an aqueous solution.
89. The hydrogel of embodiment 88, which is a water-enhancing, fire-suppressant, useful for one or more of fire-fighting, fire-suppression, and fire-prevention.
90. The hydrogel of embodiment 88 or 89, wherein the hydrogel exhibits non-Newtonian fluidic, pseudoplastic or thixotropic behaviour.
91. The hydrogel of any one of embodiments 88 to 90, wherein the hydrogel's viscosity decreases under stress.
92. The hydrogel of embodiment 90 or 91, wherein the hydrogel's viscosity increases after the stress ceases or has been removed.
93. A method of firefighting comprising applying the hydrogel of any one of embodiments 88 to 92 to a fire.
94. A method of firefighting comprising dissolving the composition of any one of embodiments 1 to 87 in water or an aqueous solution to form a hydrogel, and applying the hydrogel to a fire.
95. The method of embodiment 93 or 94, wherein the fire is a Class A fire, a Class B fire, a Class C fire, a Class D fire, a Class K fire, or a mixture thereof.
96. The method of embodiment 93 or 94, wherein the fire is a Class A fire.
97. The method of embodiment 93 or 94, wherein the fire is a Class B fire.

To gain a better understanding of the invention described herein, the following examples are set forth. It should be understood that these examples are for illustrative purposes only. Therefore, they should not limit the scope of this invention in any way.

### EXAMPLES

### Example 1: Manufacture of Compositions by Extrusion Processes

A series of representative compositions were prepared by a extrusion process comprising the following steps: 1. blending dry powders of each ingredient; 2. feeding the blend to a swin screw extruder; 3. baking the extrudate on a drying tray at 30° C. to 80° C.; 4. processing the dried extrudate through a hammer mill; 5. sieving the pellets through variable mesh screens for desired particle sizes. The extrusion conditions are summarized below.

A trial was performed to successfully produce a composition comprising xanthan gum (42% w/w), corn starch (29% w/w) and acacia gum (29% w/w) (Formulation A), and a composition comprising xanthan gum (42% w/w), corn starch (29% w/w) and guar gum (29% w/w) (Formulation B). The compositions were prepared by extrusion using the following parameters.

TABLE 1

| Parameter | Formulation A | Formulation B |
|---|---|---|
| Feed Rate (kg/hr) | 15.4 | 14.8 |
| Water Flow (kg/hr) | 3.5 | 4.9 |
| Total Moisture (%) | 28.9 | 32.8 |
| Barrel Zone 1 (° C.) | 20 | 20 |
| Barrel Zone 2 (° C.) | 30 | 30 |
| Barrel Zone 3 (° C.) | 30 | 30 |
| Barrel Zone 4 (° C.) | 30 | 30 |
| Barrel Zone 5 (° C.) | 30 | 30 |
| Barrel Zone 6 (° C.) | 30 | 30 |
| Die Temperature | 47 | 60 |
| SME (kJ/kg) | 571.4 | 562.5 |
| Screw Speed (rpm) | 152 | 150 |
| Cutter Speed (rpm) | 1500 | 810 |

Two further trials were performed to successfully prepare a composition from a blend of xanthan gum (42% w/w), corn starch (29% w/w) and guar gum (29% w/w) by extrusion using the following parameters.

TABLE 2

| Parameter | Trial 1 | Trial 2 |
|---|---|---|
| Feed Rate (kg/hr) | 14.3 | 15.0 |
| Water Flow (kg/hr) | 4.7 | 4.5 |
| Total Moisture (%) | 32.6 | 31.1 |
| Barrel Zone 1 (° C.) | 20 | 20 |
| Barrel Zone 2 (° C.) | 30 | 30 |
| Barrel Zone 3 (° C.) | 30 | 30 |
| Barrel Zone 4 (° C.) | 30 | 30 |
| Barrel Zone 5 (° C.) | 30 | 30 |
| Barrel Zone 6 (° C.) | 30 | 30 |
| Die Temperature | 61 | 62 |
| SME (kJ/kg) | 568.4 | 613.6 |
| Screw Speed (rpm) | 150 | 199 |
| Cutter Speed (rpm) | 1139 | 1143 |

### Example 2: Comparative Testing of Hydrogel Preparation and Performance

Comparative studies to demonstrate the difference between the compositions of the present application and various powder and granular water additives currently used in the firefighting industry.

Products Studied
Tetra KO® (a granulate composition comprising corn starch)—Earth Clean
Fire Ice® (a dry concentrate comprising polyacrylate polymer)—Geltech Solutions
Bulk mix of 42% xanthan gum, 29% guar gum and 29% corn starch
Samples D-J of compositions having various mesh sizes and water content (see Table 3)
FireRein Eco-Gel™ liquid concentrate was used as control and produced a hydrogel within 12 seconds of addition to the reactor.

TABLE 3

| | | | | Moisture |
|---|---|---|---|---|
| | | Milling | Sieve | content |
| Sample | Composition | Mesh Size | Screen | (%) |
| D | 42% Xanthan | 1.27 mm | #170 | 11.85 |
| | Gum | | 0.088 mm | |
| | 29% Guar Gum | | | |
| | 29% Corn Starch | | | |
| E | 42% Xanthan | 1.27 mm | #170 | 9.46 |
| | Gum | | 0.088 mm | |
| | 29% Acacia Gum | | | |
| | 29% Corn Starch | | | |
| F | 42% Xanthan | 1.27 mm | #35 | 10.94 |
| | Gum | | 0.5 mm | |
| | 29% Guar Gum | | | |
| | 29% Corn Starch | | | |
| G | 42% Xanthan | 3.175 mm | #35 | 10.69 |
| | Gum | | 0.5 mm | |
| | 29% Guar Gum | | | |
| | 29% Corn Starch | | | |
| H | 42% Xanthan | 3.175 mm | #35 | 8.93 |
| | Gum | | 0.5 mm | |
| | 29% Acacia Gum | | | |
| | 29% Corn Starch | | | |
| I | 42% Xanthan | 1.27 mm | #16 | 9.23 |
| | Gum | | 1.18 mm | |
| | 29% Guar Gum | | | |
| | 29% Corn Starch | | | |
| J | 42% Xanthan | 3.175 mm | #16 | 8.9 |
| | Gum | | 1.18 mm | |
| | 29% Acacia Gum | | | |
| | 29% Corn Starch | | | |

### Methodology

Stir Tank Reactor Solubility

During this study 1.5% by weight (262 g) of each sample of solid product was added to 17.5 kg of water in a stir tank reactor equipped with a mixing paddle with two baffles at room temperature. In each case, the sample of solid product was dropped into the water in a single addition from a height of 18 inches (45.72 cm). The amount of airborne dust was monitored following addition of the solid samples to the water. The degree of adhesion of the solids to the side vessel was also monitored. After five minutes of stirring the added solid product, the solution was evaluated for quality of “gel” and particles remaining.

Observations were collected regarding: the amount of airborne dust; the time for gel formation; and the amount of particles remaining undissolved or unsuspended in the formed gel.

Static Solubility Test—During this study a tablespoon of the solid product sample was added to the surface of a container of water to provide information regarding the specific density and coagulation of each product. In each case, the material was evaluated to determine whether it was able to readily dissolve and/or suspend in the water (“particle distribution”) or whether it clumped or agglomerated to form “chunks” (“clumping”).

### Results

In each case observations from the Stir Tank Reactor Solubility study, were qualitatively assessed and given an evaluation of from 1 to 3, where 1 was a poor result, 2 was a fair result, and 3 was a good result.

The results were tallied to identify the best performing materials. The results are summarized in Table 4 below.

TABLE 4

| | | Gel | | | |
|---|---|---|---|---|---|
| | Airborne | Formation | Particles | Clean | |
| Material | Dust | (5 min) | Remaining | Up | Total |
| Bulk Mixed Powders | 1 | 3 | 1 | 2 | 7 |
| Fire Ice ® | 1 | 3 | 3 | 1 | 8 |
| Tetra KO ® | 1 | 2 (kept | 3 | 1 | 7 |
| | | swelling) | | | |
| Sample D | 3 | 3 | 3 | 3 | 12 |
| Sample E | 2 | 3 | 3 | 3 | 11 |
| Sample F | 3 | 1 | 1 | 3 | 8 |
| Sample G | 3 | 1 | 1 | 3 | 8 |
| Sample H | 3 | 3 | 3 | 3 | 12 |
| Sample I | 3 | 1 | 1 | 3 | 8 |

In each case observations from the Static Solubility study, were qualitatively assessed and given an evaluation of from 1 to 3, where 1 was a poor result, 2 was a fair result, and 3 was a good result.

The results were tallied to identify the best performing materials. The results are summarized in Table 5 below.

TABLE 5

| | Particle | | |
|---|---|---|---|
| Material | Distribution | Clumping | Total |
| Bulk Mixed Powders | 1 | 1 | 2 |
| Fire Ice ® | 2 | 3 | 5 |
| Tetra KO ® | 1 | 1 | 2 |
| Sample D | 1 | 1 | 2 |
| Sample E | 1 | 1 | 2 |
| Sample F | 2 | 2 | 4 |
| Sample G | 3 | 1 | 4 |
| Sample H | 3 | 2 | 5 |
| Sample I | 3 | 3 | 6 |

The above results demonstrate that each of the samples of compositions provided herein performed at least as well as the commercially available products in the stir tank reactor study, and better than the bulk mix of ingredient powders. Interestingly, all the hydrogels prepared using the compositions provided herein were much more easily cleaned up than the two commercial products tested. Also, all but one of the compositions of the present application were rated “good” for the lack of dust formation; the remaining sample E was rated “fair,” which was still better than the “poor” rating given to the current commercial products.

The results of the static solubility study suggested that larger particle size can be valuable, particularly for static mixing. Samples D and E were prepared using a final sieving step using a screen of only 0.088 mm, such that the compositions comprised particles greater than 0.088 mm in size. All of samples F, G, H and I performed better than D and E in the static solubility study. Samples F, G and H were prepared using a final sieving step using a screen of 0.5 mm, such that the compositions comprised particles greater than 0.5 mm in size. Sample I was prepared using a final sieving step using a screen of 1.18 mm, such that the compositions comprised particles greater than 1.18 mm in size, but was milled at an average particle size of 1.27 mm, which is less than the average particle size of Samples G and H.

Overall, Sample H scored the best in terms of clean up, dust, solubility, and hydrogel formation. Although samples D and E did not score high in the static solubility study, they performed well in the stir reactor solubility study, which means that they would function well in commercial use where the water was being agitated prior to the addition of the material. Sample H demonstrated the best balance of solubility while maintaining a resistance to clumping with essentially no dust formation.

The Fire Ice® sample produced a good gel but was found to be too reactive to water. If it was not carefully or gradually added to the water properly it would cause clogging of equipment or formation of chunks. The gel was observed to continue to thicken and absorb water as mixing progressed. Fire Ice® also produced the most dust of all the products tested. The dust also stuck to the sides of the mixing vessel and initially floated on the top of the water during the static mixing study, but readily mixed with the water when whisked.

The Fire Ice® gel was difficult to clean up and did not readily dilute with the addition of more water.

The gel formed from Tetra KO® continued to thicken and absorb water during mixing in the stir reactor; it became very thick and viscous to the point that it was not able to coat vertical surfaces (it simple fell off). Tetra KO® produced minimal dust when added to the water, in comparison to Fire Ice®, but it was a chunky powder that was difficult to pour. Even the residual powder left in the dispensing cup was difficult to clean off. Also there was dust adhesion observed on the sides of the stir tank reactor.

The Tetra KO® gel was very difficult to clean up.

### Conclusions

The results of the comparative studies showed that the compositions of the present application are at least as effective as the currently marketed solid concentrates in forming a good hydrogel. The products in powder form that are currently on the market for producing fire suppressing gels were observed to be too reactive with water; if they were not quickly dispersed into the desired quantity of water then a non-uniform gel was formed where some parts were very thick and others not thick enough. This poses a problem when using the gel in pumps hoses etc since the thick parts of the gel can clog the hoses.

In contrast, the compositions of the present application demonstrated an effective balance of water solubility and dispersion ability, with mitigation of inhalation hazards from dust formation, and a demonstrated ease of clean up.

### Example 3: Manufacture of Compositions by Pilling and Prilling Processes and Testing of Hydrogel Preparation and Performance

### Methodology

The pellets of Table 6 were made according to one of the following procedures:

Procedure A: ¼″ Pills

Dry powder ingredients of the specified composition were mixed together. Water was added and mixing was continued until a uniform consistency was achieved. The first bolt of the ¼″ die set was placed into the fastener and a sample of the mixture was loaded. The second bolt was placed into the fastener and tightened to compress the mixture. One of the bolts was removed and the compressed mixture was pushed out until the pill was expelled. The pills were left to air dry for 24 hours.

Procedure B: Prills

Dry powder ingredients of the specified composition were mixed together. Water was added and mixing was continued until a uniform consistency was achieved. Prills were then formed either by (a) slowly pouring the mixture into a rotating 12″ diameter pan turning at 60 rpm, the prills being removed from the pan once formed; or by (b) hand-rolling the mixture into a prill using the index finger and thumb. Once formed using either method, the prills were left to air dry for 24 hours.

The pellet properties given in Table 6 were measured using the following procedures:

Procedure C: Determination of Water Content:
1. About 5.0 g of sample was accurately weighed into a weighing dish (W₀).
2. The sample was microwaved on high power (1500 W) for 10 seconds.
3. The sample was weighed.
4. Steps 2 and 3 were repeated until three consecutive constant weights are recorded (W_{c}).
5. The water content was determined using the formula: water content=100%*(W₀−W_{c})/W₀.

Procedure D: Determination of Angle of Repose:
1. Twenty pills or prills were placed on one end of a 15 cm by 30 cm glass plate.
2. The plate was lifted until the pills or prills rolled off of the plate.
3. The angle of the plate to the table in step 2 was measured.

Procedure E: Determination of Average Pill or Prill Length:
1. Pills or prills were poured along a ruler.
2. The average length was determined by counting the number of pills or prills lying along a 12 cm section of the ruler.

TABLE 6

| | | | Water | | Average pill or |
|---|---|---|---|---|---|
| | | | content | Angle of | prill length |
| Sample | Composition | Procedure | (%) | repose | (cm) |
| J | 7.3 g Corn Starch | A | 14.0 | 13° | 0.66 |
| | 7.3 g Guar Gum | | | | |
| | 10.5 g Xanthan Gum | | | | |
| | 25.0 g Water | | | | |
| K | 3.6 g Corn Starch | A; pills then | 16.0 | 15° | 0.05 |
| | 3.6 g Guar Gum | ground to 0.05 | | | |
| | 5.2 g Acacia Gum | cm length | | | |
| | 3.0 g Water | | | | |
| H | See Table 3 | See Table 3 | 10.0 | 15° | 0.05 |
| L | 3.6 g Corn Starch | B | 11.3 | 12° | 0.4 |
| | 3.6 g Guar Gum | | | | |
| | 5.2 g Xanthan Gum | | | | |
| | 12.4 g Water | | | | |
| M | 5.4 g Corn Starch | B | 12.1 | 17° | 0.46 |
| | 5.4 g Guar Gum | | | | |
| | 7.8 g Acacia Gum | | | | |
| | 3.0 g Water | | | | |
| N | 7.2 g Hydroxypropyl | B | 30.0 | 16.5° | 0.52 |
| | cellulose | | | | |
| | 7.2 g Guar Gum | | | | |
| | 10.5 g Xanthan Gum | | | | |
| | 9.0 g Water | | | | |
| O | 7.2 g Hydroxyethyl | B | 44.0 | 17° | 0.63 |
| | cellulose | | | | |
| | 7.2 g Guar Gum | | | | |
| | 10.5 g Xanthan Gum | | | | |
| | 12.4 g Water | | | | |
| P | 7.2 g Glucose | B | 18.0 | 12° | 0.41 |
| | 7.2 g Guar Gum | | | | |
| | 10.5 g Xanthan Gum | | | | |
| | 8.0 g Water | | | | |
| Q | 7.2 g Glucose | A | 20.0 | 12° | 0.81 |
| | 7.2 g Guar Gum | | | | |
| | 10.5 g Xanthan Gum | | | | |
| | 8.0 g Water | | | | |
| R | 7.2 g Hydroxypropyl | A | 14.0 | 16° | 0.80 |
| | cellulose | | | | |
| | 7.2 g Guar Gum | | | | |
| | 10.5 g Xanthan Gum | | | | |
| | 9.0 g Water | | | | |
| S | 7.2 g Hydroxyethyl | A | 14.0 | 15° | 0.80 |
| | cellulose | | | | |
| | 7.2 g Guar Gum | | | | |
| | 10.5 g Xanthan Gum | | | | |
| | 12.4 g Water | | | | |
| T | 7.2 g Corn Starch | A | 12.0 | 15° | 0.60 |
| | 7.2 g Lignosulfonate | | | | |
| | 10.5 g Xanthan Gum | | | | |
| | 10.0 g Water | | | | |
| U | 7.2 g Corn Starch | B | 14.0 | 12° | 0.52 |
| | 7.2 g Lignosulfonate | | | | |
| | 10.5 g Xanthan Gum | | | | |
| | 10.0 g Water | | | | |
| V | 7.2 g Corn Starch | A | 16.0 | 12.5° | 0.71 |
| | 7.2 g Hydroxyethyl | | | | |
| | cellulose | | | | |
| | 10.5 g Xanthan Gum | | | | |
| | 25.0 g Water | | | | |
| W | 7.2 g Corn Starch | B | 12.0 | 12.5° | 0.46 |
| | 7.2 g Hydroxyethyl | | | | |
| | cellulose | | | | |
| | 10.5 g Xanthan Gum | | | | |
| | 25.0 g Water | | | | |
| X | 7.2 g Corn Starch | A | 12.0 | 12.5° | 0.86 |
| | 7.2 g Acacia Gum | | | | |
| | 10.5 g Xanthan Gum | | | | |
| | 10.0 g Water | | | | |
| Y | 7.2 g Corn Starch | B | 14.0 | 12° | 0.63 |
| | 7.2 g Acacia Gum | | | | |
| | 10.5 g Xanthan Gum | | | | |
| | 10.0 g Water | | | | |
| Z | 7.2 g Corn Starch | B | 14.0 | 12° | 0.71 |
| | 7.2 g Guar Gum | | | | |
| | 10.5 g Lignosulfonate | | | | |
| | 10.0 g Water | | | | |
| AA | 13.0 g Corn Starch | A | 40.0 | 20° | 0.67 |
| | 13.0 g Guar Gum | | | | |
| | 6.8 g Hydroxyethyl | | | | |
| | cellulose | | | | |
| | 60.0 g Water | | | | |
| AB | 13.0 g Corn Starch | B | 32.0 | 20° | 0.44 |
| | 13.0 g Guar Gum | | | | |
| | 6.8 g Hydroxyethyl | | | | |
| | cellulose | | | | |
| | 60.0 g Water | | | | |
| AC | 11.6 g Corn Starch | B | 16.0 | 12.5° | 0.52 |
| | 11.6 g Guar Gum | | | | |
| | 16.8 g Acacia Gum | | | | |
| | 20.0 g Water | | | | |
| AD | 11.6 g Corn Starch | A | 18.0 | 12° | 0.80 |
| | 11.6 g Guar Gum | | | | |
| | 16.8 g Acacia Gum | | | | |
| | 20.0 g Water | | | | |
| AE | 6.0 g Corn Starch | B | 34.0 | 15° | 0.55 |
| | 5.6 g Guar Gum | | | | |
| | 8.4 g Xanthan Gum | | | | |
| | 20.0 g Glucose | | | | |
| | 20.0 g Water | | | | |
| AF | 10.4 g Corn Starch | B | 10.0 | 13° | 0.44 |
| | 10.4 g Guar Gum | | | | |
| | 15.2 g Xanthan Gum | | | | |
| | 4.0 g Lignosulfonate | | | | |
| | 25.0 g Water | | | | |
| AG | 10.4 g Corn Starch | A | 12.0 | 12° | 0.71 |
| | 10.4 g Guar Gum | | | | |
| | 15.2 g Xanthan Gum | | | | |
| | 4.0 g Lignosulfonate | | | | |
| | 25.0 g Water | | | | |
| AH | 10.4 g Corn Starch | B | 18.0 | 12° | 0.50 |
| | 10.4 g Guar Gum | | | | |
| | 15.2 g Xanthan Gum | | | | |
| | 4.0 g Glass spheres | | | | |
| | 35.0 g Water | | | | |
| AI | 10.4 g Corn Starch | A | 14.0 | 12° | 0.8 |
| | 10.4 g Guar Gum | | | | |
| | 15.2 g Xanthan Gum | | | | |
| | 4.0 g Glass spheres | | | | |
| | 35.0 g Water | | | | |
| AJ | 10.4 g Corn Starch | B | 10.0 | 13° | 0.32 |
| | 10.4 g Guar Gum | | | | |
| | 15.2 g Xanthan Gum | | | | |
| | 6.0 g Canola Oil | | | | |
| | 35.0 g Water | | | | |
| AK | 10.4 g Corn Starch | A | 14.0 | 14° | 0.40 |
| | 10.4 g Guar Gum | | | | |
| | 15.2 g Xanthan Gum | | | | |
| | 6.0 g Canola Oil | | | | |
| | 35.0 g Water | | | | |
| AL | 10.4 g Corn Starch | B | 10.5 | 12° | 0.32 |
| | 10.4 g Guar Gum | | | | |
| | 15.2 g Xanthan Gum | | | | |
| | 4.0 g Sodium Chloride | | | | |
| | 35.0 g Water | | | | |
| AM | 10.4 g Corn Starch | A | 12.0 | 12° | 0.38 |
| | 10.4 g Guar Gum | | | | |
| | 15.2 g Xanthan Gum | | | | |
| | 4.0 g Sodium Chloride | | | | |
| | 35.0 g Water | | | | |
| AN | 10.4 g Corn Starch | B | 10.0 | 12° | 0.40 |
| | 10.4 g Guar Gum | | | | |
| | 15.2 g Xanthan Gum | | | | |
| | 4.0 g Sodium Bicarbonate | | | | |
| | 35.0 g Water | | | | |
| AO | 10.4 g Corn Starch | A | 10.0 | 12° | 0.50 |
| | 10.4 g Guar Gum | | | | |
| | 15.2 g Xanthan Gum | | | | |
| | 4.0 g Sodium Bicarbonate | | | | |
| | 35.0 g Water | | | | |

### Results

Pellets (pills and/or prills) were successfully made for all of the compositions given in Table 6, demonstrating that the compositions and methods of the invention are compatible with a variety of thickening agents and additives. Clumping was not observed when any of the samples in Table 6 was dissolved in water, and essentially no dust formation was observed.

### Example 4: Burn Tests

### Methodology

Burn tests were conducted to determine the ability of hydrogels formed from specific pellet compositions to resist a direct flame. Pills and prills were dissolved in water at a concentration of 0.74 wt % to form the tested hydrogels. On each day of testing, a control hydrogel composition, made by dissolving in water a liquid concentrate containing an equivalent mass of starch and gums as the pellet compositions, was also tested. Multiple burn times of the control composition were obtained on the same day and averaged to set the reference value for that day's sample testing. This allowed data to be normalized across multiple days of testing and across different surfaces used during the tests. Burn times of the tested compositions are reported in Table 7 as a percentage of the burn time of the control composition. Sample Z* consisted of the composition of sample Z made into pills according to procedure A, rather than prills.

### Results

TABLE 7

| | Burn time | SD |
|---|---|---|
| Sample | (% control hydrogel) | (%) |
| Control composition | 100 | 10 |
| V | 134 | 4 |
| W | 123 | 4 |
| N | 129 | 5 |
| AF | 165 | 17 |
| AG | 188 | 11 |
| Z* | 72 | 7 |
| Z | 94 | 6 |
| AD | 79 | 1 |
| AC | 70 | 5 |
| J | 69 | 9 |
| L | 72 | 4 |

Table 7 shows that the tested compositions of the present invention are effective at forming water-enhancing, fire-suppressing hydrogels.

In particular, hydrogels formed from pellet compositions comprising a cellulose derivative in place of starch or gum as a thickening agent showed better burn times. Cellulose derivatives may exhibit improved heat capacity compared to starch, which may be due to alteration of their chain length, degree of remaining chain bundling (intrinsic 3D structure), or interactions with other thickening agents as a result of derivatization of cellulose side chains. The derivatization of cellulose side chains may also cause cellulose derivatives to perform better than starch at retarding the evaporation of the water in the hydrogel, leading to longer burn times, either through intrinsic interactions of the derivatized side chains with the water, or through enhancement of lattice-forming properties with other thickening agents in the compositions.

Hydrogels comprising lignosulfonate as an extra thickening agent in addition to gums and starch also showed better burn times. This may be a result of the increased viscosities observed in such hydrogels, and/or the intumescent properties of lignosulfonate.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

Although the foregoing invention has been described in some detail by way of illustration and example for purposes of clarity of understanding, it is readily apparent to those of ordinary skill in the art in light of the teachings of this invention that certain changes and modifications may be made thereto without departing from the scope of the appended claims.

What is claimed is:

1. A composition comprising pellets comprising two or more biopolymeric thickening agents.

2. The composition of claim 1, wherein the two or more biopolymeric thickening agents are non-toxic and biodegradable.

3. The composition of claim 1, wherein at least one of the two or more biopolymeric thickening agents is a polysaccharide.

4. The composition of claim 3, wherein the polysaccharide is starch, a polysaccharide gum, or a cellulosic polymer.

5. The composition of claim 4, wherein the polysaccharide gum is xanthan gum, guar gum, acacia gum, diutan gum, welan gum, gellan gum, or a mixture thereof.

6. The composition of claim 4, wherein the starch is corn starch, wheat starch, arrowroot, potato starch, tapioca, rice starch, or a mixture thereof.

7. The composition of claim 4, wherein the cellulosic polymer is cellulose, carboxymethylcellulose, hydroxyethylcellulose, hydroxypropylcellulose, or a mixture thereof.

8. The composition of claim 1, wherein the two or more biopolymeric thickening agents comprise at least one starch and at least one polysaccharide gum.

9. The composition of claim 1, wherein the two or more biopolymeric thickening agents comprise at least one polysaccharide gum and at least one cellulosic polymer.

10. The composition of claim 1, wherein the two or more biopolymeric thickening agents comprise at least one starch, at least one polysaccharide gum, and at least one cellulosic polymer.

11. The composition of claim 10, wherein the two or more biopolymeric thickening agents comprise at least one starch, two or more polysaccharide gums, and at least one cellulosic polymer.

12. The composition of claim 1, wherein the two or more biopolymeric thickening agents further comprise at least one lignin.

13. The composition of claim 12, wherein the lignin is Kraft lignin, lignosulfonate, organosolv lignin, soda lignin, or a mixture thereof.

14. The composition of claim 1, wherein the pellets are compressed, sheared, and/or heated.

15. The composition of claim 1, wherein the pellets are obtained from an extrusion process, a prilling process, a pilling process or a briquetting process.

16. The composition of claim 1, wherein the composition consists of >75%, >80%, >85%, >90%, >95%, >98% or 100%, by weight, consumer-grade components.

17. The composition of claim 16, wherein the consumer-grade components are food-grade.

18. A hydrogel, comprising: 0.1-30 wt % of the composition of claim 1; and 70-99.9 wt % of water or an aqueous solution, wherein the hydrogel is a water-enhancing, fire-suppressant, useful for one or more of fire-fighting, fire-suppression, and fire-prevention.

19. The hydrogel of claim 18, wherein the hydrogel exhibits non-Newtonian fluidic, pseudoplastic or thixotropic behaviour.

20. The hydrogel of claim 18, wherein the hydrogel's viscosity decreases under stress, and the hydrogel's viscosity increases after the stress ceases or has been removed.
